(19) United States
(12) Patent Application Publication
(10) Pub. No.: US 2021/0368506 A1
(43) Pub. Date: Nov. 25, 2021

(54) COMMUNICATION APPARATUS, CONTROL METHOD OF COMMUNICATION APPARATUS, AND COMPUTER-READABLE STORAGE MEDIUM

(71) Applicant: CANON KABUSHIKI KAISHA, Tokyo (JP)

(72) Inventor: Yuki Yoshikawa, Kanagawa (JP)

(21) Appl. No.: 17/396,801

(22) Filed: Aug. 9, 2021

Related U.S. Application Data
(63) Continuation of application No. PCT/JP2019/050358, filed on Dec. 23, 2019.

(30) Foreign Application Priority Data
Feb. 15, 2019 (JP) 2019-025785

(51) Int. Cl. H04W 72/04; H04L 5/00

(52) U.S. Cl. CPC H04W 72/0453; H04W 72/0493; H04L 5/0007

(57) ABSTRACT

There is provided a communication apparatus allocating to one or more terminal stations, respective resource units obtained by dividing a predetermined frequency band for OFDMA (Orthogonal Frequency-Division Multiplexing Access) communication with the communication apparatus; and notifying the one or more terminal stations of information which is distinguishable whether to perform uplink communication to the communication apparatus or perform downlink communication from the communication apparatus in each of the allocated resource units.

### CROSS-REFERENCE TO RELATED APPLICATIONS

This application is a Continuation of International Patent Application No. PCT/JP2019/050358, filed Dec. 23, 2019, which claims the benefit of Japanese Patent Application No. 2019-025785, filed Feb. 15, 2019, both of which are hereby incorporated by reference herein in their entirety.

### BACKGROUND OF THE INVENTION

### Field of the Invention

The present invention relates to a frequency band allocation control technique for communication.

### Background Art

The level of information transmitted and received by wireless communication is becoming higher from text data to image data and from image data to moving image data, and the communication amount is also increasing. On the other hand, since the frequency band usable for wireless communication is limited, in order to increase the communication capacity, it is requested to improve the frequency utilization efficiency by multiplexing signals at high density in various dimensions such as the time, frequency, code, and space. To achieve this, in a wireless LAN (Local Area Network), it has been attempted to increase the communication capacity by introducing methods such as advanced multileveling in a modulation method, channel bonding, and MIMO (Multiple-Input and Multiple-Output). For example, IEEE (Institute of Electrical and Electronics Engineers) is studying IEEE802.11ax as a next-generation wireless LAN standard with high efficiency (HE (High Efficiency)). In IEEE802.11ax, in order to improve the frequency utilization efficiency, it is proposed to employ OFDMA (Orthogonal Frequency-Division Multiplexing Access) that enables the structure of a frequency channel, in which the 20-MHz frequency bandwidth has been conventionally used as a unit, to be allocated to a plurality of terminals on a narrower frequency bandwidth basis. Note that OFDMA is the abbreviation of Orthogonal Frequency-Division Multiplexing Access, and a multi-user (MU) communication method in which signals of a plurality of users are multiplexed. In IEEE802.11ax, at least a portion of the 20-MHz frequency band is allocated to each of up to nine users by OFDMA. For example, if the number of users is one, the entire 20-MHz frequency band may be allocated to the one user. On the other hand, if the number of users is two or more, non-overlapping portions (RUs (resource units)) of the 20-MHz frequency band are allocated to the respective users. Similarly, when the 40-MHz, 80-MHz, or 160-MHz frequency band is used, at least portions of the frequency band are allocated to up to 18, 37, or 74 users. With this, even if a plurality of users hold data that they want to transmit at the same time, the waiting time for data transmission due to carrier sense or the like is reduced.

Japanese Patent Laid-Open No. 2018-527770 discloses that in MU communication in a wireless LAN, an AP (access point) transmits a frame called a trigger frame describing information of the frequency band that each STA (station) can use to transmit data. More specifically, during a connection process, the AP assigns an AID (Association ID) to each STA, and transmits a trigger frame describing the AID value. Each STA can transmit data held by itself in accordance with the information included in the received trigger frame.

According to Japanese Patent Laid-Open No. 2018-527770, each of a plurality of STAs is provided with a data transmission opportunity in the uplink, but Japanese Patent Laid-Open No. 2018-527770 does not mention a data transmission opportunity in the downlink. That is, Japanese Patent Laid-Open No. 2018-527770 does not mention that each STA transmits data, and obtains the data transmission opportunity from the AP at the same time. If the data transmission opportunity is provided to each of the plurality of STAs but the AP cannot be provided with the data transmission opportunity at the same time, the following problems may occur. That is, even when the STA connects an external network via the AP and requests data transmission/reception that requires responsiveness such as in a network game, the AP cannot transmit data until the data transmission from the STA ends. Accordingly, a user manipulating the STA, which operates by receiving data from the external network, is forced to manipulate a poor responsiveness UI (User Interface). Further, when the STA transmits data to another STA that links to the same AP, since the AP cannot transfer data until a next transmission opportunity, the AP needs to hold a large-capacity buffer for temporarily storing the data to be transferred. If the amount of transmitted data to be transferred exceeds the capacity of the buffer, the data has to be discarded. Furthermore, the STA must always wait data transmission while the AP is transmitting data. Therefore, when data transfer is required, data transmission by the STA and data transfer by the AP cause a larger overhead.

### SUMMARY OF THE INVENTION

The present disclosure provides, in consideration of the above problems, a technique for providing a transmission opportunity to each of an STA and an AP.

There is provided a communication apparatus comprising: allocation unit configured to allocate, to one or more terminal stations, respective resource units obtained by dividing a predetermined frequency band for OFDMA (Orthogonal Frequency-Division Multiplexing Access) communication with the communication apparatus; and notification unit configured to notify the one or more terminal stations of information which is distinguishable whether to perform uplink communication to the communication apparatus or perform downlink communication from the communication apparatus in each of the allocated resource units.

According to the present invention, it becomes possible to provide a transmission opportunity to each of an STA and an AP.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a view showing a configuration example of a network:

FIG. 2 is a block diagram showing an example of the functional arrangement of an AP:

FIG. 3 is a block diagram showing an example of the hardware arrangement of the AP:

FIG. 4 is a flowchart illustrating an example of the procedure of an RU allocation process performed by an AP in the first and second embodiments:

FIG. 5 is a flowchart illustrating an example of the procedure of an UL/DL data transmission/reception process performed by the AP in the first and second embodiments;

FIG. 6 is a flowchart illustrating an example of the procedure of the UL/DL data transmission/reception process performed by an STA in the first and second embodiments;

FIG. 7 is a timing chart showing the procedure of UL/DL data transmission/reception operations of the AP and the STAs in the first and second embodiments;

FIG. 8 is a view showing an example of the structure of a trigger frame in the first and second embodiments;

FIG. 9 is a view showing an example of tone size allocation in 20 MHz:

FIG. 10 is a flowchart illustrating an example of the procedure of a connection process between the AP and the STAs in the second embodiment; and

FIG. 11 is a view showing an example of the frame structure of an association response in the second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate.

Furthermore, in the attached drawings, the same reference numerals are given to the same or similar configurations, and redundant description thereof is omitted.

(Configuration of Wireless Communication System)

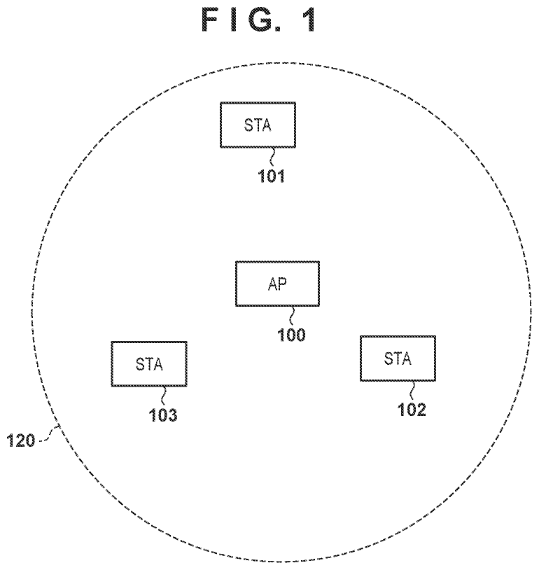

FIG. 1 shows a configuration example of a network in an embodiment according to the present invention. FIG. 1 shows a configuration including three STAs (terminal stations) 101 to 103 and one AP 100 as HE (High Efficiency) devices. As shown in FIG. 1, the range within which a signal transmitted by the AP 100 can be received is indicated by a circle 120, and a signal transmitted by the AP 100 can be received by all the STAs 101 to 103. The AP 100 and respective STAs 101 to 103 are connected in the 20-MHz band, unless otherwise specified. However, this is merely an example, and a following discussion is applicable to, for example, a network including many HE devices and legacy devices in a wide region, and the positional relationship between various communication apparatuses.

In the network configuration shown in FIG. 1, the STAs 101 to 103 perform MU communication (multi-user communication) with the AP 100. Each of the AP 100 and the STAs 101 to 103 holds transmission data. For example, assume that the STA 101 holds data for the STA 102, and each of the STA 102 and the STA 103 holds data for an external network to which the AP 100 connects. Further, assume that the AP 100 holds data obtained from the external network and to be transmitted to the STA 103.

(Arrangement of AP 100)

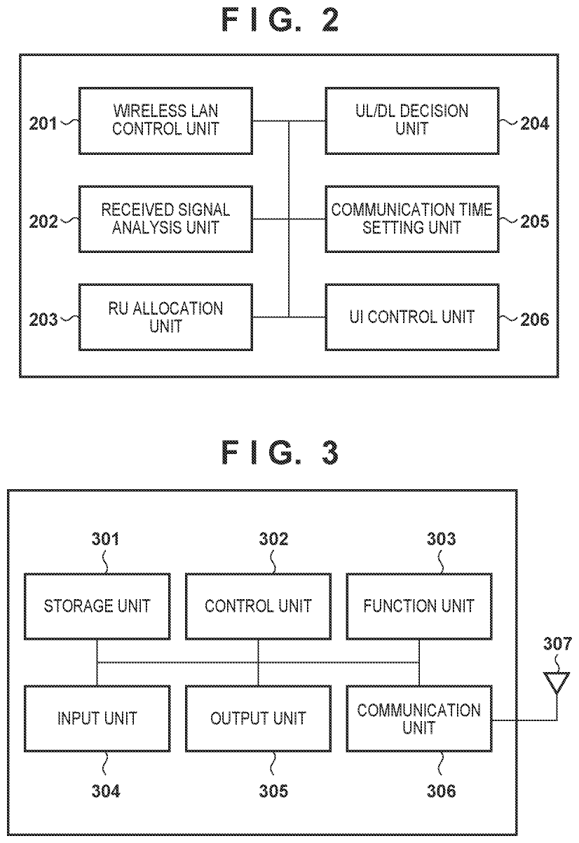

FIG. 2 is a block diagram showing an example of the functional arrangement of the AP 100. The AP 100 includes, as an example of its functional arrangement, a wireless LAN control unit 201, a received signal analysis unit 202, an RU allocation unit 203, a UL/DL decision unit 204, a communication time setting unit 205, and a UI control unit 206.

The wireless LAN control unit 201 performs wireless LAN communication control via a communication unit 306 (FIG. 3) in accordance with the IEEE802.11 standard series. For example, the wireless LAN control unit 201 transmits a trigger frame to the STA whose authentication is completed, and receives a response thereto. The received signal analysis unit 202 analyzes the contents included in the signal received by the wireless LAN control unit 201. For example, the received signal analysis unit 202 obtains, from the received signal, information of the data amount to be transmitted by the STA as the transmission source of the signal (the amount of data stored in a buffer by the STA). The RU allocation unit 203 allocates an RU (Resource Unit (predetermined frequency band)) to each of one or more STAs. That is, the RU allocation unit 203 decides and allocates, for each of one or more STAs, the width of the frequency band for communication and its center frequency. The allocation can be performed based on the information obtained by the received signal analysis unit 202. The UL/DL decision unit 204 decides which one of uplink communication (UL communication) (STA→AP) and downlink communication (DL communication) (AP→STA) is performed in each RU allocated by the RU allocation unit 203. The communication time setting unit 205 sets a communication time to perform communication in the RU allocated by the RU allocation unit 203. The UI control unit 206 controls an input operation by a user (not shown) of the AP 100 to an input unit 304 (FIG. 3), and controls an output to an output unit 305 (FIG. 3).

Note that although the functional arrangement of each of the STAs 101 to 103 is not shown, each STA is configured to include the wireless LAN control unit 201, the received signal analysis unit 202, and the UI control unit 206.

FIG. 3 is a block diagram showing an example of the hardware arrangement of the AP 100. The AP 100 includes, as an example of its hardware arrangement, a storage unit 301, a control unit 302, a function unit 303, the input unit 304, the output unit 305, the communication unit 306, and an antenna 307.

The storage unit 301 is formed by both of a ROM (Read Only Memory) and a RAM (Random Access Memory) or one of them, and stores programs for performing various kinds of operations to be described later and various kinds of information such as communication parameters for wireless communication. Note that other than the memories such as a ROM and a RAM, a storage medium such as a flexible disk, a hard disk, an optical disk, a magnetooptical disk, a CD-ROM, a CD-R, a magnetic tape, a non-volatile memory card, or a DVD may be used as the storage unit 301.

The control unit 302 is formed by, for example, a processor such as a CPU (Central Processing Unit) or an MPU (Micro Processing Unit), an ASIC (Application Specific Integrated Circuit), a DSP (Digital Signal Processor), an FPGA (Field Programmable Gate Array), or the like. The control unit 302 controls the entire AP 100 by executing the programs stored in the storage unit 301. Note that the control unit 302 may control the entire AP 100 in cooperation with the programs stored in the storage unit 301 and an OS (Operation System).

Further, the control unit 302 controls the function unit 303 to perform a predetermined process such as image capturing, printing, or projection. The function unit 303 is hardware used by the AP 100 to perform a predetermined process. For example, if the AP 100 is a camera, the function unit 303 is an image capturing unit and performs an image capturing process. For example, if the AP 100 is a printer, the function unit 303 is a printing unit and performs a printing process. For example, if the AP 100 is a projector, the function unit 303 is a projection unit and performs a projection process. Data to be processed by the function unit 303 may be data stored in the storage unit 301, or may be data communicated with another apparatus via the communication unit 306 to be described later.

The input unit 304 accepts various kinds of operations from a user. The output unit 305 performs various kinds of outputs for the user. Here, the output by the output unit 305 includes at least one of display on a screen, audio output by a loudspeaker, vibration output, and the like. Note that both the input unit 304 and the output unit 305 may be implemented by one module as a UI, like a touch panel.

The communication unit 306 controls wireless communication complying with the IEEE802.11 standard series, or controls IP communication. In some embodiments to be described below, the communication unit 306 can perform a process complying with at least the IEEE802.11ax standard. In addition, the communication unit 306 controls the antenna 307 to transmit and receive radio signals for wireless communication. The AP 100 communicates a content such as image data, document data, or video data with another communication apparatus via the communication unit 306. Note that the hardware arrangement of each of the STAs 101 to 103 is similar to that shown in FIG. 3.

(Procedure of Process)

Next, operations of the AP 100 and the STAs 101 to 103 in the arrangement as described above will be described.

### First Embodiment

In this embodiment, an AP 100 allocates an RU to each STA, and decides which one of UL communication and DL communication is performed in the allocated RU. Then, the AP 100 notifies each STA of information indicating which one of UL communication and DL communication is performed in each RU by adding the information to a trigger frame.

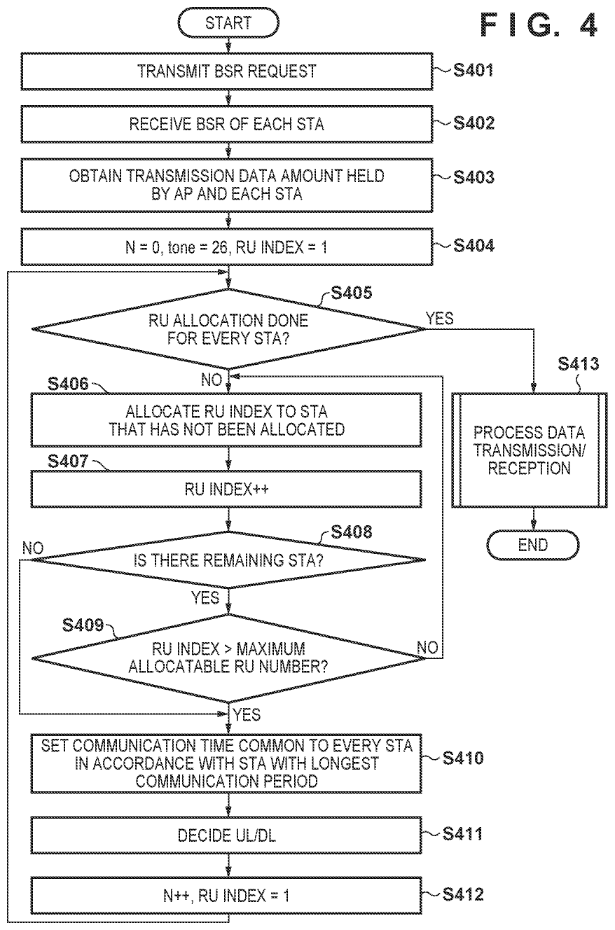

FIG. 4 illustrates an example of the procedure of an RU allocation process performed by the AP 100 in this embodiment. This process can be started when the AP 100 performs MU UL/DL communication. Note that authentication is completed between each of STAs 101 to 103 and the AP 100, and they are in a state in which they can transmit/receive data to/from each other. The process in this flowchart is implemented by, for example, a control unit 302 of the AP 100 executing a program stored in a storage unit 301.

A wireless LAN control unit 201 transmits a BSR (Buffer Status Report) request to the STAs 101 to 103 as a trigger for receiving a BSR from each of the STAs 101 to 103 (step S401). Then, the wireless LAN control unit 201 receives the BSR from each of the STAs 101 to 103 as a response to the transmitted BSR request (step S402). A received signal analysis unit 202 obtains the data amount (transmission data amount) of data to be transmitted, which is held in the buffer of each of the STAs 101 to 103, by analyzing the received BSR (step S403).

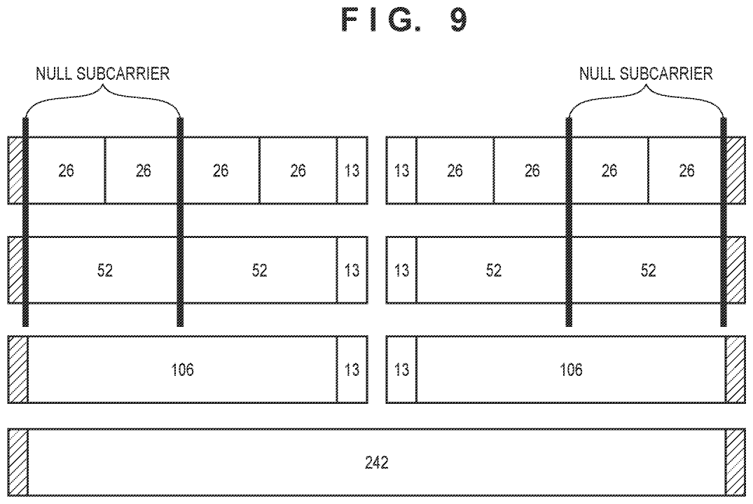

While setting a group number N=0, a tone size=52, and an RU index=1, which indicates the RU allocation position, as initial values, following processing operations (steps S405 to S412) are repeated until the RU allocation (grouping) for all the STAs is completed (steps S404 and S405). The group number is an index given to one group. Here, one group includes a plurality of STAs, that can perform communication at the same time, or one STA. The tone size is a value indicating the width of the frequency band (that is, RU) that can be allocated to each STA. FIG. 9 shows an example of the tone size and the width of the frequency band (RU) to be allocated in 20 MHz. As shown in FIG. 9, if the tone size=52, the RUs are allocated to up to four STAs. Note that the tone size can be allocated similarly in a case of 40 MHz or 80 MHz.

In step S406, an RU allocation unit 203 sequentially allocates the RU index to, among the STAs to be allocated with RUs, the STA that has not been allocated with the RU index. Here, the STAs to be allocated with RUs are the STA which is to transmit data in the UL (UL data transmitting STA) and the STA (as the transmission destination of data from the AP) which is to receive data in the DL (DL data receiving STA). In this embodiment, the STA whose data amount obtained in step S403 is larger than a predetermined threshold value is regarded as the UL data transmitting STA, and the STA which is to receive the data amount larger than a predetermined threshold value from the AP 100 is regarded as the DL data receiving STA. After allocating the RU index to the STA which has not been allocated with the RU index, the RU allocation unit 203 increments the RU index (step S407), and checks whether there is the STA which has not been allocated with the RU index (step S408). If there is the STA which has not been allocated with the RU index, the RU allocation unit 203 checks whether the RU index does not exceed the maximum number of allocatable RUs with the current tone size (step S409). If the RU index does not exceed the maximum number, the process returns to step S406. If there is no STA that has not been allocated with the RU in step S408 or if the RU index exceeds the maximum number in step S409, the process advances to step S410.

In step S410, a communication time setting unit 205 sets a communication time common to all the STAs belonging to the group of the group number N in accordance with the STA which has the longest communication time among the STAs allocated with the RU indices (step S410). The communication time can be calculated from the transmission data amount, the allocated RU frequency, and the like. Here, as has been described above, the STAs allocated with the RU indices include the UL data transmitting STA and the DL data receiving STA, and the data amount of the DL data receiving STA can be the data amount to be transmitted to the specific STA by the AP 100. Note that the data amount to be transmitted by the AP 100 may be the total data amount to be transmitted by the AP 100 without limiting the STA.

In step S411, a UL/DL decision unit 204 decides which one of UL communication and DL communication is performed in each RU corresponding to the RU index allocated in step S406. That is, the UL/DL decision unit 204 decides that UL communication is performed if the STA allocated with the RU index is the UL data transmitting STA, and DL communication is performed if the STA allocated with the RU index is the DL data receiving STA.

After the process up to step S411 is completed, in step S412, the RU allocation unit 203 increments the group number N and returns the RU index to 1, and the process returns to step S405. These processing operations are repeated until the RUs are allocated to all the STAs. If the RU index allocation is completed for all the STAs, the process transitions to a data transmission/reception process (step S413).

In this embodiment, when the group number N=0 and the tone size=52, the RU index=1 is allocated to the STA 103 serving as the DL data receiving STA, and the RU indices=2 to 4 are allocated to the STAs 101 to 103 serving as the UL data transmitting STAs. Accordingly, DL communication is performed in the RU corresponding to the RU index=1, and UL communication is performed in each of the RUs corresponding to the RU indices=2 to 4.

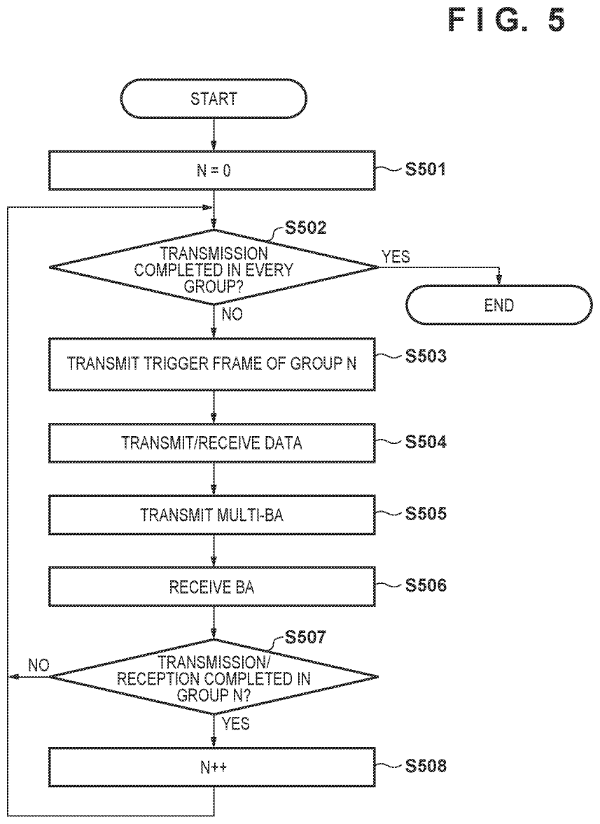

Next, the data transmission/reception process in step S413 will be described. FIG. 5 shows an example of the procedure of the UL/DL data transmission/reception process. After the RU index allocation for all the STAs by the RU allocation unit 203 is completed, the wireless LAN control unit 201 performs the following processing operations (steps S503 to S507) for each group. First, one group is selected as a target group in the order from the group number N=0, and the process is started (step S501). The wireless LAN control unit 201 transmits a trigger frame to each STA belonging to the target group (step S503).

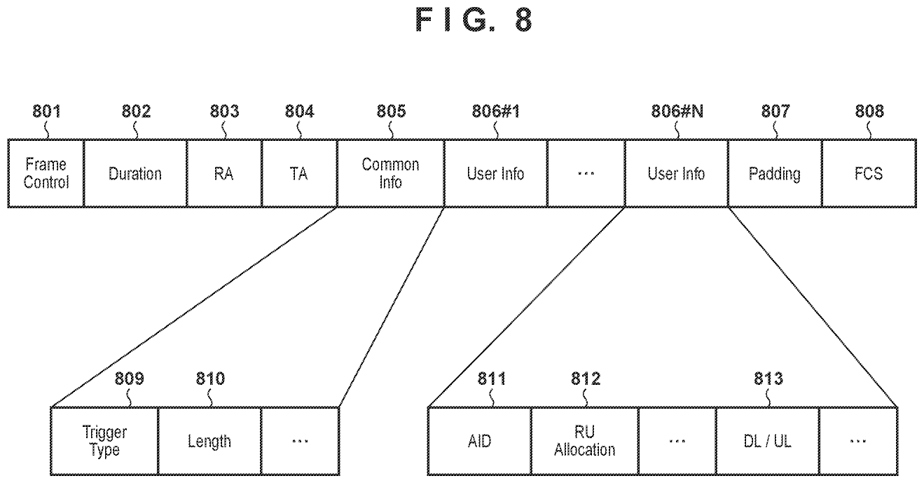

FIG. 8 shows an example of the structure of the trigger frame. Fields/subfields 801 to 812 comply with the IEEE802.11ax standard. In FIG. 8, the Trigger Type subfield 809 in the Common Info field 805 indicates the trigger type. In a case of the trigger frame, the Trigger Type subfield 809 indicates 0.

The Length subfield 810 in the Common Info field 805 indicates the communication time common to all the STAs. The communication time corresponds to the data amount that each STA can transmit/receive. If the Trigger Type subfield 809 indicates 0, the User Info field 806 is added. The AID subfield 811 for specifying the STA and the RU Allocation subfield 812 for specifying the allocated RU and tone size of the STA are prepared here. The DL/UL bit 813 indicates which one of UL communication and DL communication is performed in the allocated RU and tone size. For example, the DL/UL bit 813 is set to 0 if UL communication is performed, and the DL/UL bit 813 is set to 1 if DL communication is performed. In this embodiment, in a case of allocation for the STA 103 serving as the DL data receiving STA with the RU index=1, the User Info field 806 is set as follows, for example. That is, the AID subfield 811=the AID allocated to the STA 103, the RU Allocation subfield 812=37, and the DL/UL bit 813=1. In a case of allocation for the STA 101 serving as the UL data transmitting STA with the RU index=2, the AID subfield 811=the AID allocated to the STA 101, the RU Allocation subfield 812=38, and the DL/UL bit 813=0.

Each of the STAs 101 to 103, serving as the UL data transmitting STA and allocated with the respective values in the User Info field 806, transmits a UL data frame (PPDU (PLCP (Physical Layer Convergence Protocol) Protocol Data Unit)). The STA 103 serving as the DL data receiving STA prepares to receive data from the AP 100 in the allocated RU. If the UL data frames are received from the STAs 101 to 103 serving as the UL data transmitting STAs (step S504), the AP 100 returns a multi-block Ack (multi-BA) to each of the STAs 101 to 103 (step S505). With the multi-BA, each of the STAs 101 to 103 can check whether the UL data frame has been correctly received by the AP 100. Further, the AP 100 transmits a DL data frame to the STA 103 serving as the DL data receiving STA (step S504), and receives a block Ack (BA) from the STA 103 (step S506). With this, the AP 100 can confirm that the DL data frame has reached the STA 103. Note that in the example illustrated in FIG. 5, the AP 100 transmits the multi-BA and then receives the BA, but the order may be reversed.

Note that the order (multi-BA transmission→BA reception) set in this embodiment leads to advantages as follows. If the STA 103 only receives a DL data frame without transmitting a UL data frame, the STA 103 cannot know the timing of returning a BA after receiving the DL data frame. This is because there is a possibility that data transmission/reception continues in the RU that was not allocated to the STA 103. There is also a possibility that the BA conflicts with the multi-BA transmitted from the AP 100. Thus, by returning the BA after a wait until the AP 100 transmits the multi-BA to the STAs 101 to 102, the STA 103 can reliably inform the AP 100 that the data has been received.

As the method of returning the BA, the following method is also conceivable. For example, this is a method in which the STA returns the BA in the RU allocated to itself. With this method, the STA which is to transmit the BA need not wait for the multi-BA transmitted by the AP 100. If the BA is returned after the multi-BA, this uses the entire 20-MHz band, and an overhead occurs. However, by returning the BA in the allocated frequency (RU)/time, the overhead can be reduced and the occupancy of the radio frequency can be decreased.

After the processing operations in steps S503 to S507 are performed for each group and data transmission and reception are completed in all the groups, the data transmission/reception process is terminated.

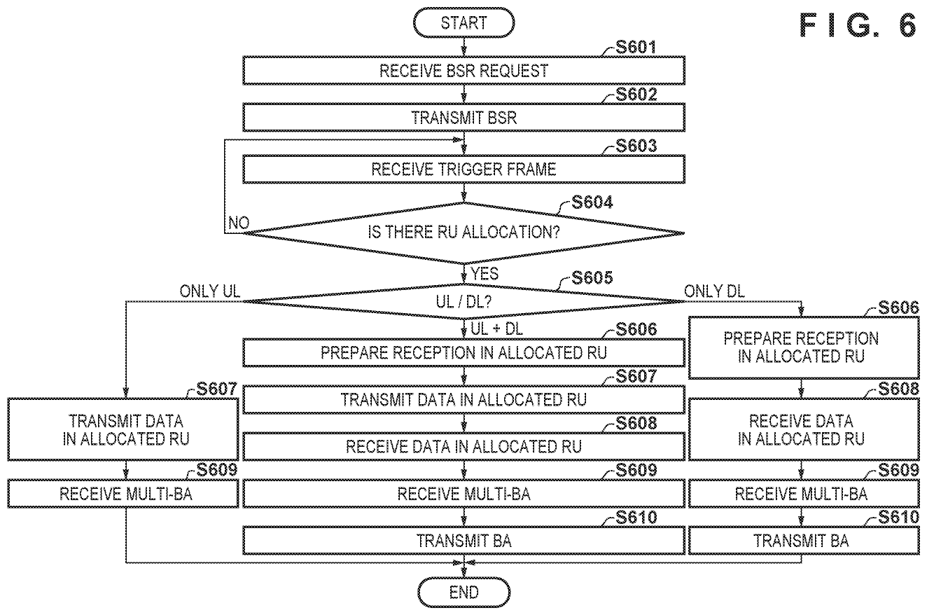

Next, the process in each of the STAs 101 to 103 according to this embodiment will be described. FIG. 6 illustrates an example of the procedure of the UL/DL data transmission/reception process performed by the STA in this embodiment. This process can be started when the AP 100 performs MU UL/DL communication. Note that the processing operations in steps S604 and S605 can be performed by the received signal analysis unit 202 of the STA, and other processing operations can be performed by the wireless LAN control unit 201 of the STA. In the description of FIG. 6, the STAs 101 to 103 are collectively referred to as the STA.

The STA receives, from the AP 100, a BSR request as a trigger for receiving a BSR (step S601). The STA having received the BSR request transmits a BSR (step S602). After this, the STA receives a trigger frame from the AP 100 (step S603). The STA reads the AID subfield 811 from the User Info field 806 in the trigger frame, and checks whether the AID of the self-STA is described therein. That is, the STA checks whether a specific RU is allocated to the self-STA (step S604). If the specific RU is allocated, the STA further checks the RU Allocation subfield 812 and the DL/UL but 813 in the User Info field 806 (step S605). That is, the STA determines whether the RU allocated to the self-STA is only the RU for DL data transmission or only the RU for UL data transmission, or both RUs are allocated. Note that if no RU is allocated (No in step S604), the STA waits for reception of a trigger frame again.

In step S605, if the RU allocated to the self-STA is only the RU for UL data transmission, the process advances to step S607. In step S607, the STA transmits a UL data frame in the allocated RU (step S607), and waits for reception of a corresponding multi-BA (step S609). If completion of transmission of the UL data frame is successfully confirmed, the process is terminated. On the other hand, if the RU allocated to the self-STA is only the RU for DL data transmission, the process advances to step S606. In step S606, the STA waits for reception of a DL data frame in the allocated RU. If a DL data frame is received in the allocated RU (step S608), the STA waits for reception of a multi-BA from the AP 100 (step S609). After that, if a multi-BA is received, the STA transmits a BA corresponding to the received DL data frame (step S610). If the DL data frame is successfully received, the process is terminated. If both the RU for UL data transmission and the RU for DL data transmission are allocated to the self-STA, the process advances to step S606. The processing operations from steps S606 to S610 are as described above. If the STA can correctly transmit and receive data, the process is terminated.

If the STA could not correctly transmit a UL data frame, it updates the queue size and retransmits the UL data frame. Examples of a case in which the STA could not correctly transmit a UL data frame is a case in which no Ack including a multi-BA is returned from the AP 100, a case in which the AID of the self-STA is not included in the received multi-BA, and a case in which the received frame is not an authentic frame. In the case of retransmission, the STA may transmit the data in an OFDMA group after a wait of a trigger frame. Alternatively, the STA may transmit data after career sense in accordance with a means before IEEE802.11ac.

If the STA could not correctly receive the DL data frame, either of STA reallocation by the AP 100 in the trigger frame or data reception without RU allocation can be performed. Examples of a case in which the DL data frame could not be correctly received are a case in which the DL data frame or the multi-BA could not be received from the AP 100 and a case in which the BA cannot be returned for some reason.

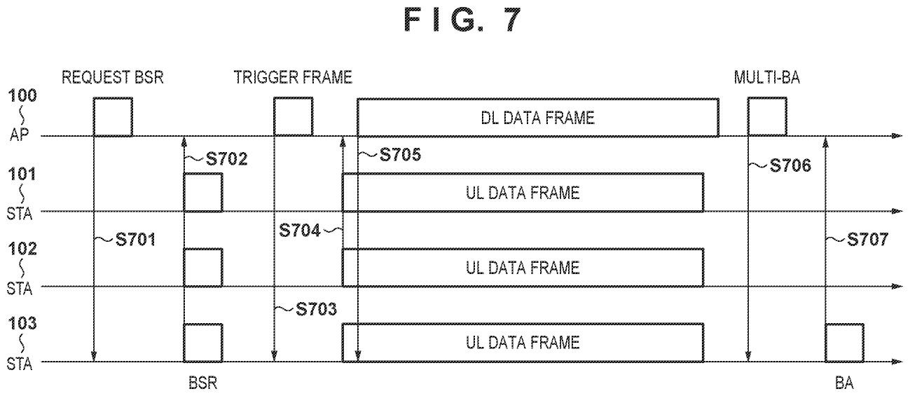

FIG. 7 illustrates the procedure of UL/DL data transmission/reception operations of the AP 100 and the STAs 101 to 103. First, the AP 100 transmits a BSR request (step S701). Each of the STAs 101 to 103 transmits a BSR (step S702). If the BSR is received from each of the STAs 101 to 103, the AP 100 allocates an RU based on the data amount included in the BSR, and transmits a trigger frame including the RU allocation information (step S703). Here, as has been described above, the AP 100 allocates the RUs to the STAs 101 to 103 serving as the UL data transmitting STAs and the STA 103 serving as the DL data receiving STA, and transmits a trigger frame including the RU allocation information. When the trigger frame is received, each of the STAs 101 to 103 serving as the UL data transmitting STAs transmits a UL data frame within the range of data amount decided from the Length subfield 810 (step S704). The STA 103 serving as the DL data receiving STA waits for data reception in the allocated RU (step S705). If the UL data frame is received from each of the STAs 101 to 103, the AP 100 transmits a multi-BA as a receiving confirmation (step S706). If the DL data frame is received from the AP 100, the STA 103 transmits a BA as a receiving confirmation (step S707).

Note that each of the STAs 101 to 103 may transmit the BSR to the AP 100 at an arbitrary timing. That is, each of the STAs 101 to 103 may add a frame serving as the BSR to the UL data frame. Alternatively, the AP 100 may read the data equivalent to the BSR based on the UL data transmitted by each of the STAs 101 to 103. Based on the queue size corresponding to the data, the AP 100 can analyze information that can be obtained from the BSR.

As has been described above, by transmitting the trigger frame while adding the UL/DL information thereto, the AP 100 can receive data from the STAs 101 to 103 while transmitting data. For example, when a user using the STA 103 activates a game application or the like that requires the real-time characteristic but the data amount to be simultaneously transmitted is not large, it becomes possible to implement data transmission and reception more quickly by simultaneously performing the data transmission and reception with the AP 100.

Note that in this embodiment, the RU allocation to the STA is performed only with the tone size=52, but the bandwidth is merely an example, and allocation may be performed using another value. For example, allocation may be performed with the tone size=26. In this case, up to nine STAs are allocated to one group. The tone size may be changed in accordance with the number of STAs in data communication with the AP, or the number of STAs holding transmission data. For example, it is conceivable that the tone size=52 is set if the number of STAs holding transmission data is eight, and the tone size=26 is set if the number of STAs holding transmission data becomes nine. With this, respective STAs can transmit more data at the same time to the AP while using the band efficiently.

Further, in this embodiment, the RU is allocated to the STA (AP) holding the data mount larger than the predetermined threshold value, but the RU allocation may be performed regardless of the data amount. For example, the RU indices=1 and 2 may be allocated to the STA 101 serving as the UL data transmitting STA and the DL data receiving STA, respectively, and the RU indices=3 and 4 may be allocated to the STA 102 serving as the UL data transmitting STA and the DL data receiving STA, respectively. After this allocation, the data transmission/reception period is set to be sufficiently long, for example, 1 h or the like. This can implement an application with higher responsiveness. That is, during the 1 h set as the data transmission/reception period, a dedicated line from the AP is prepared to implement more smooth data communication. The above-described options may be switched in accordance with the implemented application.

In this embodiment, it has been assumed that the STA 101 transmits data to the STA 102 via the AP 100. In the embodiment described above, the STA 101 can achieve data transmission to the AP 100 after the first RU allocation by the AP 100. On the other hand, data transmission (transfer) from the AP 100 to the STA 102 can be achieved after the second RU allocation. In such a situation, the AP 100 may expect that the data transmission from the STA 101 to the STA 102 has not been completed, and estimate the more or longer frequency band for DL to the STA 102 in the second RU allocation. With this, the AP can receive data from the STA 101 in the second RU allocation period, and transfer it to the STA 102 in the same period. Accordingly, the AP 100 can reduce the buffer amount prepared for transfer, and can quickly perform data transmission from the STA 101 to the STA 102. That is, it becomes possible to return a response more quickly to the STA using an application having high immediacy. Further, in a case in which the STA requests data transfer from the AP, its overhead can be reduced.

In this embodiment, the bit (DL/UL bit 813) included in the User Info Field 806 in the trigger frame is used as the information indicating UL/DL, but another location may be used. For example, the AP 100 may decide to use, as the frequency band for DL communication, all the frequency band which has not been allocated for UL communication. With this, the AP 100 can reduce the amount of information included in the trigger frame. Alternatively, a bit indicating UL/DL may be prepared in the Common Info field 805. In this case, if the bit is 0, all the STAs holding UL data may be targets in the succeeding User Info fields 806. If the bit is 1, all the STAs (that are to receive DL data) may be targets in the succeeding User Info fields 806. With this, if the STA holds no UL data, the STA can determine whether to discard the received trigger frame before analyzing the contents of the User Info fields 806.

Further, in this embodiment, the RU is allocated to the UL data transmitting STA or the DL data receiving STA (that is, AP) based on the transmission data amount, but the STAs as RU allocation targets are not limited to them. For example, in accordance with the access category value of data held by the STA, the RUs may be allocated in the order from the STA having the highest priority. With this, the AP can preferentially receive data having the high access category value.

### Second Embodiment

The second embodiment is similar to the first embodiment in that an AP 100 allocates an RU to each STA and decides which one of UL communication and DL communication is performed in the allocated RU, but a notification method to each STA is different from that in the first embodiment. That is, in the first embodiment, a notification is made by adding predetermined information to a trigger frame, but in the second embodiment, a notification as to which one of UL communication and DL communication is performed in each RU is made without changing an existing form of a trigger frame. A description of duplication of the first embodiment will not be repeated below.

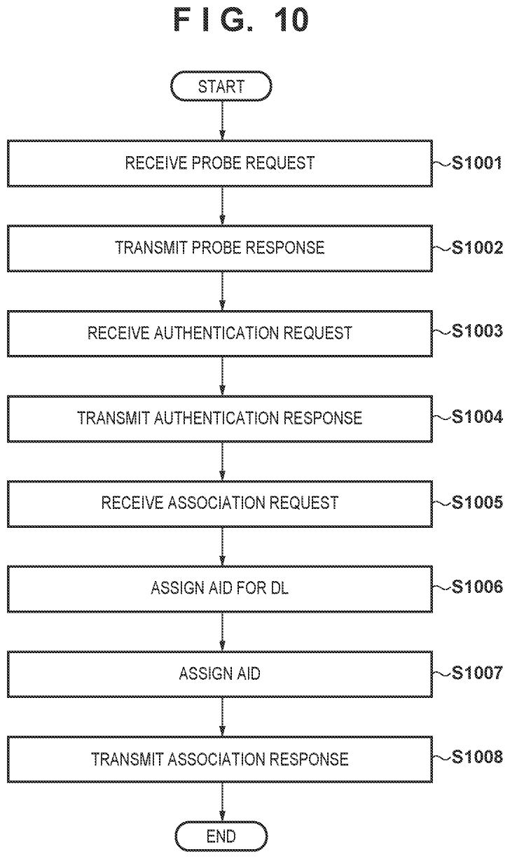

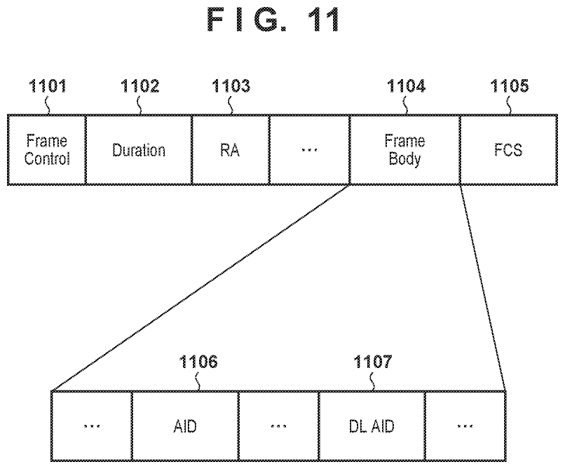

FIG. 10 illustrates an example of the procedure of a connection process between the AP 100 and STAs 101 to 103 according to this embodiment. This process can be started when the AP 100 starts operating as an AP. The process in this flowchart is implemented by, for example, a control unit 302 of the AP 100 executing a program stored in a storage unit 301. Note that in the description of FIG. 10, the STAs 101 to 103 are collectively referred to as the STA.

A wireless LAN control unit 201 receives a probe request from the STA (step S1001), and transmits a probe response as a response to the probe request (step S1002). Then, the wireless LAN control unit 201 transmits an authentication response in response to reception of an authentication request (steps S1003 and S1004). Thereafter, the wireless LAN control unit 201 transmits an association response in response to reception of an association request from the STA (steps S1005 and S1008). The wireless LAN control unit 201 describes an AID allocated to each STA in the association response transmitted at this time (step S1007). In this embodiment, the wireless LAN control unit 201 further allocates a DL AID to each STA in addition to the AID, and describes it in the association response (step S1006). Note that FIG. 10 is merely an example, and a similar AID description procedure can be applied to an association response in another connection process.

FIG. 11 shows an example of the frame structure of the association response according to this embodiment. Fields/subfields 1102 to 1105 comply with the IEEE802.11ax standard. An AID 1106 and a DL AID 1107 allocated in steps S1006 and S1007 are described in the Frame Body 1104 of the association response. In this embodiment, the AID=6 and the DL AID=7 are allocated to the STA 103 serving as the DL data receiving STA. Note that another means for indicating the DL AID may be used. For example, since the Frame Body 1104 of the association response can describe Vendor Specific information, this information may indicate the value of the DL AID. With this, it is possible to add information without contention with the existing association response.

The RU allocation process performed by the AP 100 is similar to that in the procedure of FIG. 4 described in the first embodiment, and a description thereof will be omitted. The UL/DL data transmission/reception process performed by the AP 100 is similar to that in the procedure of FIG. 5 described in the embodiment, but the form of a trigger frame transmitted in step S503 is different. That is, the AP 100 transmits the trigger frame as shown in FIG. 8, but there is no DL/UL bit 813 in this embodiment. Instead, the AP 100 notifies each STA of UL communication or DL communication by indicating the DL AID or the normal AID in an AID subfield 811. That is, if the AP 100 wants to allocate a UL RU to the STA 103, the AID=6 is described in the AID subfield 811. If the AP 100 wants to allocate a DL RU, the AID=7 is described in the AID subfield 811.

As has been described above, according to this embodiment, in addition to the effects described in the first embodiment, it is possible to make a notification to the STA by allocating the DL AID in advance without adding new information to the trigger frame.

Note that in this embodiment, the DL AID is allocated to each STA, but a special AID may be used as the DL AID. For example, the AID=2046 is treated as indicating that the UL data transmitting STA is not allocated. It is conceivable that the ADI=2046 is allocated to a given frequency band in the trigger frame, and the AP transmits data to each STA in the given frequency band. In this case, without limiting the STA as a data transmission destination at the time of transmitting the trigger frame, the AP can reserve the frequency band in which the AP itself can transmit data. This is advantageous in a case in which the AP 100 receives, from the STA 101 in connection, data to be transferred to the STA 102. In this case, within the period allocated to the trigger frame, the STA 101 can transmit data to the STA 102 via the AP 100. That is, the AP 100 can quickly respond to the data to be transferred to the STA 102.

Note that in the embodiment described above, the AP 100 can simultaneously allocate the RU for UL data transmission and the RU for data reception to the single STA, but the AP 100 may be configured not to simultaneously allocate the two types of RUs. For example, if the two types of RUs are allocated to the single STA, the AP 100 may individually allocate the RU for UL data transmission and the RU for DL data reception to the STA in separate trigger frames.

Alternatively, a bit (information) indicating that both the RU for UL data transmission and the RU for DL data reception can be simultaneously allocated may be prepared in a frame transmitted by each of the STAs 101 to 103 or the AP 100. In this case, for example, if the STA 101 transmits a frame including this bit, the AP 100 can simultaneously allocate the two types of RUs to the STA 101. Further, for example, if the AP 100 transmits a frame including this bit, each of the STAs 101 to 103 can recognize that the two types of RUs can be allocated in a succeeding trigger frame.

According to the present invention, it becomes possible to provide a transmission opportunity to each of an STA and an AP.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication apparatus comprising:
allocation unit configured to allocate, to one or more terminal stations, respective resource units obtained by dividing a predetermined frequency band for OFDMA (Orthogonal Frequency-Division Multiplexing Access) communication with the communication apparatus; and
notification unit configured to notify the one or more terminal stations of information which is distinguishable whether to perform uplink communication to the communication apparatus or perform downlink communication from the communication apparatus in each of the allocated resource units.

2. The communication apparatus according to claim 1, wherein
the number of resource units in the predetermined frequency band is decided in advance, and the allocation unit allocates the resource units to the terminal stations up to the number of resource units.

3. The communication apparatus according to claim 1, wherein
the allocation unit allocates the resource unit to a terminal station holding data to be transmitted having an amount exceeding a predetermined threshold value and/or a terminal station serving as a transmission destination of data to be transmitted from the communication apparatus having an amount exceeding the predetermined threshold value.

4. The communication apparatus according to claim 3, wherein
the notification unit notifies that the uplink communication is performed in the resource unit allocated to the terminal station holding the data to be transmitted having the amount exceeding the predetermined threshold value.

5. The communication apparatus according to claim 3, wherein
the notification unit notifies that the downlink communication is performed in the resource unit allocated to the terminal station serving as the transmission destination of the data to be transmitted from the communication apparatus having the amount exceeding the predetermined threshold.

6. The communication apparatus according to claim 1, wherein
the allocation unit allocates a first plurality of resource units to a first terminal station, and a second plurality of resource units different from the first plurality of resource units to a second terminal station, and
the notification unit notifies that one of the uplink communication and the downlink communication is performed in the first plurality of resource units, and one of the uplink communication and the downlink communication is performed in the second plurality of resource units allocated to the second terminal station.

7. The communication apparatus according to claim 1, wherein
the notification unit performs the notification using a trigger frame.

8. The communication apparatus according to claim 7, wherein
the notification unit performs the notification by adding, to the trigger frame, one of information indicating that the uplink communication is performed in the each of the allocated resource unit and information indicating that the downlink communication is performed in the each of the allocated resource unit.

9. The communication apparatus according to claim 7, wherein
the notification unit performs the notification by indicating, in an AID (Association ID) field in the trigger frame, one of information indicating that the uplink communication is performed in the each of the allocated resource unit and information indicating that the downlink communication is performed in the each of the allocated resource unit.

10. The communication apparatus according to claim 8, wherein
the trigger frame is formed to include the information indicating that the uplink communication is performed and the information indicating that the downlink communication is performed.

11. A control method of a communication apparatus, comprising:
an allocation step of allocating, to one or more terminal stations, respective resource units in a predetermined frequency band for OFDMA (Orthogonal Frequency-Division Multiplexing Access) communication with the communication apparatus; and
a notification step of notifying the one or more terminal stations of information which is distinguishable whether to perform uplink communication to the communication apparatus or perform downlink communication from the communication apparatus in each of the allocated resource units.

12. A computer readable storage medium storing a program for causing a computer to function as a communication apparatus according to claim 1.
